(19) United States
(12) Patent Application Publication
(10) Pub. No.: US 2018/0132440 A1
(43) Pub. Date: May 17, 2018

(54) Plant Grow Train

(71) Applicants: James Eaves, Quebec City (CA); Marina Eaves, Charlestown, RI (US)

(72) Inventor: James Eaves, Quebec City (CA)

(21) Appl. No.: 15/797,082

(22) Filed: Oct. 30, 2017

Related U.S. Application Data
(60) Provisional application No. 62/414,994, filed on Oct. 31, 2016.

(51) Int. Cl. A01G 31/04; A01G 7/04; A01G 27/00; A01G 29/00

(52) U.S. Cl. CPC A01G 31/04; A01G 29/00; A01G 27/00; A01G 7/045

(57) ABSTRACT

A plant-growing-train system includes at least one convoy of maneuverable growing units, at least one centralized resource station that contains a high-intensity lighting system, and a water and nutrients delivery system. The convoy is transported to the resource station in order to expose the plants to optimal levels of light, water, and nutrients. Because the lights are high-intensity, the required amount of time plants must be exposed to light is reduced, enabling grow units to share lights and other resource infrastructure rather than having lights dedicated uniquely to each unit and resources delivered to each unit. This system substantially reduces the amount of equipment and expense required to grow plants in a controlled environment.

### FIELDS OF THE INVENTION

The invention provides a method for building and operating a horticulture system that requires far less equipment per plant, thus substantially decreasing the cost of growing plants in controlled environments.

### BACKGROUND OF THE INVENTION

Fresh fruits and vegetables not only taste better, but there is also growing scientific evidence that they are healthier. In particular, fruits and vegetables rapidly lose their nutritional content after being picked, even when they are refrigerated properly (e.g., Pandrangi and LaBorde 2004). Of course, for most places in the world, growing food outdoors is not possible all year around. In fact, only about 10% of the world's land is arable, so demand for fresh produce has driven rapid growth in Controlled Environment Agriculture (CEA), where plants are grown indoors or in greenhouses and technology is used to optimize growing conditions.

The problem is that CEA is capital intensive. Farms often require hydroponic systems, plumbing to deliver water and nutrients, and HVAC systems to control temperature and humidity. The most expensive components are the artificial lights and the electricity infrastructures necessary for powering them. For indoor farming, these components on average account for about 50% of total capital expenditures. Increasingly, greenhouses use artificial lights to supplement sunlight, so lighting systems are also an increasingly important capital expenditure of greenhouses as well. This explains why plants grown in greenhouses and indoors can cost three-times as much as plants grown using conventional techniques—in soil, outdoors.

### BRIEF SUMMARY OF THE INVENTION

The present invention comprises a high-powered lighting system that delivers a plant its required amount of light in a fraction of the time normal-powered lighting systems or the sun can deliver that requirement. This enables a train-like convoy of growing units to share the same lighting system, rather than each unit having a dedicated system, substantially reducing the capital expenditures necessary to build a farm that uses artificial lighting. The convoy of growing units can be pulled by a robot or each unit can have its own motor drive, enabling each unit to move independently to the lighting system and other resources.

Two insights underline the novelty of this invention. The first is the scientific fact that plants require a certain amount of light each day, rather than require to be exposed to light for a certain period of time. In other words, one can increase the power of lights and thus reduce the amount of time that plants must be exposed to light. The second insight is that train systems, whereby either each growing unit has a motor and can manoeuvre itself or a single robot can move one or several linked growing unit to and from the centralized resource station, is more flexible and less costly than conveyor systems, which have a centralized motor that powers a conveyor a moving track or floor. These insights imply that rather than assigning a group of plants their own lighting, water, and nutrient delivery system, light power can be increased enabling plants to share far fewer lights by moving plants to lights and other resources.

### BRIEF DESCRIPTION OF THE DRAWINGS

In the drawings, which form a part of this specification,

FIG. 1 is a birds-eye view of a train of grow units passing through a resource station that delivers high-intensity lighting, water, and nutrients.

FIG. 2 is a semi-diagrammatic, side-view of a section of a train of grow units, according to one embodiment of the invention, passing through a resource station.

### DETAILED DESCRIPTION OF THE INVENTION

A few embodiments of the invention are described in this section with the use of the enclosed drawings, which illustrate some but not all of the embodiments of the invention. In fact, these inventions may be embodied in many different forms and should not be construed as limited set forth herein; rather, these embodiments are provided so that this disclosure will satisfy applicable legal requirements.

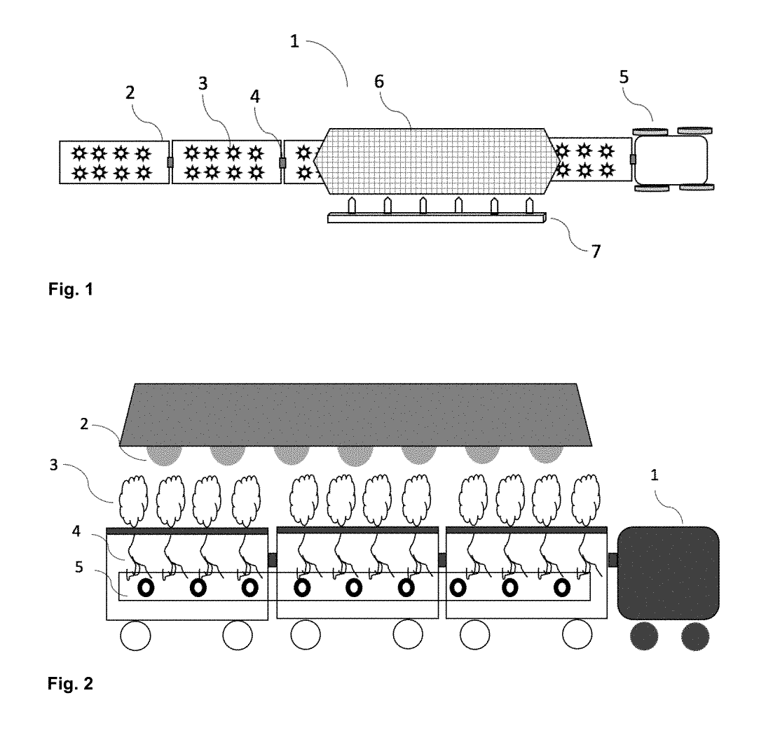

In one embodiment of the invention illustrated, the plant-growing-train system (FIG. 1, item 1) has several growing units (FIG. 1, item 2) in which plants (FIG. 1, item 3) grow. The growing units may be attached to one another (FIG. 1, item 4) so that one robot (FIG. 1, item 5) or a lead motorized growing unit can transport a convoy of growing units to and from a centralized resource station, where the plants are exposed to high-intensity lights (FIG. 1, item 6) which deliver the amount of light necessary to grow healthy plants (“the Daily Light Integral) in a fraction of the time light is typically delivered to plants either in indoor farms, greenhouses, or outdoors. Similarly, the centralized growing unit could also deliver the other necessary inputs and treatments like water, nutrients, and fungicides and pesticides using delivery mechanisms (FIG. 1 item 7). FIG. 2 shows a side-view of a convoy of growing units being pulled to the resource station by a robot or a motorized growing unit (FIG. 2, item 1), where the plants spend enough time to receive an optimal amount of light from high-intensity light units (FIG. 2, item 2). Water and other inputs are also delivered to the plants (FIG. 2, item 3) and their roots (FIG. 2, item 4) via a centralized distribution point (FIG. 2, item 5). In another embodiment, each grow unit has its own drive system and thus maneuver itself to and from the resource station. In another embodiment, plants are planted in containers of soil or another substrate.

### A. Description of Prior Art

Hence there is a need to reduce of cost and increase revenues of growing in controlled environments. Prior inventions have addressed certain aspects of this need by teaching how to reduce the labor needed to operate CEA farm, increase the quality of the plants, or increase yields per unit of space. But these inventions have not addressed how to reduce the equipment costs associated with building a CEA as addressed by this invention. In fact, the most relevant prior art uses conveyor systems to maneuver plants, which is inherently expensive since conveyors require a track and motor infrastructure that covers the entire growing and harvesting area.

For example, growing plants vertically is an increasingly popular means of growing plants because it increases yields per square foot. However, plants naturally grow against gravity, so orienting them vertically causes them to bend upwards, often lowering the market value of the plant. To address this, Brusatore (US 2010/0236147) discloses a horticulture system for the execution of a plant process where plants are grown in containers that rotate and circulate on a carousel-like apparatus, and resources are delivered to each container, including light. A slot in the containers encourage the plants to grow towards the center, and the rotations create artificial gravity that encourages the plants to grow straight towards the light even if they are to one side of the grow units.

Growing, even with CEA, is often labor intensive, as people are often needed to seed, manage resource delivery, re-space plants, and harvest the plants. So, Prohaska (US 20100269407) discloses a continuous loop growing system where a moving floor carries plants through zones that execute each stage of a plant's life-cycle, seeding, growing, harvesting, and decomposing. Pettibone (U.S. Pat. No. 8,533,993B2) discloses a continuous-loop conveyor, towering upon vertical framework, which transports plants through all growing stages, allowing production and harvesting to be automated, and improving space utilization. Other related art that uses conveyor systems that reduce the need for labor include but fail to reduce the need for equipment include Lim (2006/0162252) and Kawanabayashi (U.S. Pat. No. 4,951,415).

Again, though inventions like these have improved plant quality and reduced the need for labor, they do not address the high capital costs associated with building a greenhouse or indoor farm. In fact, such inventions likely increase capital costs. The result is that locally grown, hyper-fresh, pesticide-free fruits and vegetable remain too expensive for the vast majority of consumers.

1. A plant growing system wherein plant growing-units are maneuvered to a centralized resource station that provides high-intensity light, water, and nutrients and comprising of:
a. Growing units that may be linked together and pulled or pushed by a robot,
b. Growing units that are motorized and thus can transport themselves,
c. Growing units with one more more shelves enabling the stacking of plants,
